(19) United States
(12) Patent Application Publication
(10) Pub. No.: US 2022/0335463 A1
(43) Pub. Date: Oct. 20, 2022

(54) EVENT SERVICE PROVIDING SYSTEM USING DIGITAL TWIN OF REAL SPACE AND VIRTUAL SPACE

(71) Applicants: Ju Hyoung KIM, Yongin (KR); Won Seok LEE, Incheon (KR)

(72) Inventors: Ju Hyoung KIM, Yongin (KR); Won Seok LEE, Incheon (KR)

(21) Appl. No.: 17/723,226

(22) Filed: Apr. 18, 2022

(30) Foreign Application Priority Data
Apr. 19, 2021 (KR) 10-2021-0050693

(51) Int. Cl. G06Q 30/02

(52) U.S. Cl. CPC G06Q 30/0222

(57) ABSTRACT

Disclosed is an event service providing system using a digital twin of a real space and a virtual space, and more particularly, an event service providing system using a digital twin of a real space and a virtual space capable of securing evenness and fairness between participants competing in the offline and online stores by adjusting the difficulty according to the progress of the event held at each offline store and online store as well as securing the reliability and integrity of the determination of winners winning a prize in a process of conducting the same fusion lottery event between offline and online stores after generating an online store which is a virtual space equal to a real space using a digital twin with respect to an offline store which is a real space.

### CROSS-REFERENCE TO RELATED APPLICATIONS

This application claims the priority of Korean Patent Application No.10-2021-0050693 filed on Apr. 19, 2021, in the Korean Intellectual Property Office, the disclosure of which is incorporated herein by reference.

### BACKGROUND OF THE INVENTION

### Field of the Invention

The present disclosure relates to an event service providing system using a digital twin of a real space and a virtual space, and more particularly, to an event service providing system using a digital twin of a real space and a virtual space capable of securing evenness and fairness between participants competing in the offline and online stores by adjusting the difficulty according to the progress of the event held at each offline store and online store as well as securing the reliability and integrity of the determination of winners winning a prize in a process of conducting the same fusion lottery event between offline and online stores after generating an online store which is a virtual space equal to a real space using a digital twin with respect to an offline store which is a real space.

### Description of the Related Art

Recently, stores such as department stores and shopping malls that sell products operate online stores through the Internet as well as offline stores as real stores, which support customers who cannot visit the real stores to purchase products from the real stores online, thereby increasing product sales.

In addition, with the recent development of 3D virtual technology, customers are provided with an online store implemented in a online virtual space by capturing an offline store through a camera and as a result, customers who access the online store are provided with the same user experience as the offline store.

In addition, these stores induce a visit to an offline store or a website including an online store corresponding to the offline store by holding a prize lottery event to attract customers.

In the related art, most of these prize lottery events were held at a fixed specific place in the form of a lottery, but in the event holding method, since customers who visit the store frequently visit only the corresponding specific place and participate in the event, there is a limit that the use of the store cannot be induced.

Accordingly, recently, the prize lottery event is held in the form of a treasure hunt to induce customers to visit various shops in the store, thereby increasing store sales according to the event progress.

In addition, the offline store applies such a prize lottery event to the online store to support the customers to participate in the lottery event provided in the offline store in the online, thereby maximizing sales by holding the fusion lottery event of the offline store and the online store to increase the store usage rate of the both the offline store and the online store.

However, in the process of holding such a fusion lottery event, a first user who acquired the prize disposed in the offline store and a second user almost simultaneously acquire a virtual prize of the online store applied to the online store in the same manner as the prize disposed in the corresponding offline store, there is a problem that it is difficult to determine who is a winner of the first user and the second user.

In addition, a user who visits the offline store need to move directly in the store, whereas a user who visits the online store using a terminal may move in the store conveniently and quickly just by touching the terminal. As a result, in the process of holding the fusion lottery event, there is a problem that customers avoid visiting the offline store, and in the case of the offline store, the efficiency of the fusion lottery event decreases.

Therefore, when the fusion lottery event between the offline store and the offline store is held, there is a demand for an alternative capable of improving the user satisfaction and a customer influx effect according to the event progress in both the online store and the offline store.

The above-described technical configuration is the background art for helping in the understanding of the present disclosure, and does not mean a conventional technology widely known in the art to which the present disclosure pertains.

### SUMMARY OF THE INVENTION

An object of the present disclosure is to provide an event service providing system by generating an online store which is a 3D virtual space generated based on a digital twin for an offline store and then applying a virtual prize corresponding to a prize placed in the offline store in relation to a lottery event to the online store and providing the virtual prize to the user terminal to hold the same lottery event between the online store and the offline store and synchronizing a lottery event progress time between the offline store and the online store to accurately determine a winner acquiring the prize, thereby increasing the satisfaction of participants participating in the lottery event, and simultaneously supporting sales products to be easily exposed to users in both the online store and the offline store in the process of participating in the lottery event to increase the sales.

Another object of the present disclosure is to provide an event service providing system by adjusting the difficulty of obtaining the prize between the online store and the offline store when holding the same lottery event in the online store and the offline store to support event participants not to be concentrated in either the online store or the offline store, thereby increasing the sales according to the lottery event progress in both the online store and the offline store.

According to an aspect of the present disclosure, there is provided an event service providing system using a digital twin of a real space and a virtual space comprising a local server for managing an offline store which is a real store and a main server for communicating with the local server via a communication network. The event service providing system may include the local server that transmits synchronization information for time synchronization with the main server and generates prize finding information including time information on a prize finding time and prize identification information of the specific prize and terminal identification information of the customer terminal when a predetermined position for a prize providing means located in the offline store to store a specific prize therein and a position of the customer terminal identified through communication with one or more positioning means located in the offline store are within a predetermined reference distance to transmit the generated prize finding information to the main server, and the main server that stores online store information, which is a 3D virtual space including 3D measurement information generated based on a digital twin to correspond to the offline store, synchronizes the time with the local server based on the synchronization information, transmits the online store information to the user terminal while one or more objects matched with the one or more prize providing means located in the offline store are included in the position in the online store information matched with the positions in the offline store of the prize providing means corresponding to each object, and compares the time information of the prize finding information with the reception time of the selection information when a prize corresponding to the selection information when receiving the selection information corresponding to the object selected in the online store information from the user terminal is the same as the specific prize according to the prize finding information received from the local server to determine a winning terminal winning the specific prize in the customer terminal and the user terminal.

The main server and the local server may be configured as nodes of a blockchain, respectively, and the main server may generate a block including the prize finding information or selection information when receiving the prize finding information or the selection information and then connect the block with the other block generated immediately before the block through a block hash to store the block, and transmit the block to the local server to distribute and store the block in the local server.

The main server may pre-store prize information on a prize of the offline store matched with object identification information of the object for each of the one or more objects, the main server may include a reception time of the selection information when receiving the selection information and prize identification information extracted from the prize information matched with the object identification information of the selected object included in the selection information in the selection information, and the main server may retrieve the blockchain based on the prize finding information or the prize identification information included in the selection information when receiving the prize finding information or the selection information and compare the reception time of the selection information and the time information of the prize finding information between the received prize finding information or selection information and the prize finding information or selection information for the specific prize stored in the blockchain when selection information on the same prize as the specific prize corresponding to the received prize finding information exists or prize finding information on the same prize as the specific prize corresponding to the received selection information exists.

The main server may compare the reception time of the selection information with the time information of the prize finding information to identify a winning terminal based on terminal identification information included in the earliest comparison target information among a plurality of comparison target information including the selection information and the prize finding information, and transmit winning information to the winning terminal that has won the specific prize in the customer terminal and the user terminal.

The main server may generate the winning information for releasing a locking state of the prize providing means having a locking device so as not to receive the specific prize stored in the prize providing means before winning when the winning terminal winning the specific prize is the customer terminal to transmit the generated winning information to the local server, and the local server may generate control information for releasing the locking device of the prize providing means based on the winning information when receiving the winning information to transmit the generated control information to the prize providing means.

The main server may generate winning information including prize information including the right to receive the specific prize stored in the prize providing means located in the offline store when the winning terminal winning the specific prize is the user terminal to transmit the generated winning information to the user terminal.

The main server may generate a new block including the winning information when generating the winning information and then connects the new block with a previous block generated immediately before generating the new block based on a block hash to store the new block, and transmits the new block in the local server to distribute and store the new block in the local server.

The local server may identify one or more customer terminals located in the offline store by communicating with the one or more positioning means to calculate an average movement speed according to the number of participants in the offline store and a movement speed for each participant and generate offline event progress information including the number of participants and the average movement speed to transmit the generated offline event progress information to the main server, and the main server may generate online event progress information including the number of participants in the online store corresponding to the online store information with respect to one or more user terminals participating in a lottery event in the online store by requesting the online store information, calculate a difference value according to the comparison of the number of participants between the offline event progress information and the online event progress information and then calculate a movement speed by adding or subtracting an adjustment value corresponding to a difficulty range to which the difference value belongs to or from the average movement speed according to the offline event progress information according to a plurality of preset adjustment values for each of different difficulty ranges, and adjust the movement speed in the online store so as to move at the calculated movement speed when moving in the online store by the operation of the user terminal.

The main server may calculate a first prize finding frequency in the offline store based on the prize finding information received from the local server, calculate a second prize finding frequency in the online store based on the selection information received from the one or more user terminals, and adjust the movement speed in the online store until a difference between the first prize finding frequency and the second prize finding frequency is within a predetermined threshold.

The main server may increase the movement speed in the online store when the first prize finding frequency is higher than the second prize finding frequency and decrease the movement speed in the online store when the first prize finding frequency is lower than the second prize finding frequency.

According to the present disclosure, virtual space information having the same structure as the offline store is generated as an online store using a digital twin for the offline store and then one or more objects virtualizing one or more prize providing means storing the prize disposed in the offline store are applied to the online store to accurately determine a participant winning the prize among users who access and visit the online store and customers who actually visit the offline store through time synchronization between the local server and the main server in the process of holding the fusion lottery event for simultaneously providing the same lottery event between the offline store and the online store. In addition, the prize finding time for each of the users and the customers and the winner determination process are stored through a blockchain to increase reliability and satisfaction of the user in the lottery process of the fusion lottery event and support products to be sold in both the online store and the offline store to be exposed to the customers and the users through the fusion lottery event progress, thereby increasing the sales in both the online store and the offline store by one event progress.

Further, according to the present disclosure, considering the number of participants and the prize finding frequency and mobility with respect to participants participating in the fusion lottery event in each of the offline store and the online store, the difficulty of movement of the online store is adjusted so that the frequencies of winning prizes are similar between the offline store and the online store to secure fairness and equity in the process of holing the fusion lottery event between offline and online stores, thereby supporting participants to be evenly distributed in both offline and online stores. Accordingly, it is possible not only to support both offline and online stores to ensure the promotion efficiency of the event progress, but also to support both the offline and online stores to increase the event participation satisfaction of all participants participating in the fusion lottery event.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of an event service providing system using a digital twin of a real space and a virtual space according to an embodiment of the present disclosure;

FIGS. 2 to 5 are operation exemplary diagrams of a winner determination process according to a fusion lottery event in an event service providing system using a digital twin of a real space and a virtual space according to an embodiment of the present disclosure; and

FIG. 6 is an operation exemplary diagram of difficulty adjustment in the process of a fusion lottery event of an event service providing system using a digital twin of a real space and a virtual space according to an embodiment of the present disclosure.

### DETAILED DESCRIPTION OF THE PREFERRED EMBODIMENT

Hereinafter, detailed embodiments of the present disclosure will be described with reference to the drawings.

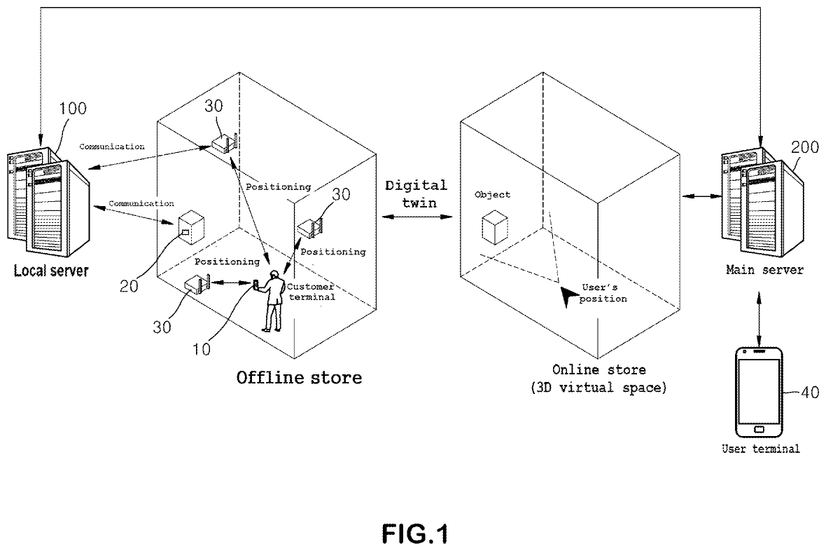

FIG. 1 is a block diagram of an event service providing system (hereinafter, an event service providing system) using a digital twin of a real space and a virtual space according to an embodiment of the present disclosure.

As illustrated in FIG. 1, the event service providing system according to the embodiment of the present disclosure maybe configured by including a local server 100 that managing an offline store as a real store, and a main server 200 that communicates with the local server 100 via a communication network, stores space information, which is a 3D virtual space virtualized with the offline store using a digital twin, and provides the space information to a user terminal 40 as online store information (or online store).

At this time, the digital twin described in the present disclosure means a virtual model that virtualizes a physical object based on a digital, and as an example of such digital twin technology, space information, which is a 3D virtual model having the same structure as that of the offline store, may be generated by photographing the offline store while moving the offline store using a plurality of cameras.

In addition, the space information includes actual measurement information of measuring the structure of the offline store based on a digital twin, and accordingly, the space information may be generated to have the same structure as that of the offline store and the same measured value as the measured value of the structure of the offline store.

In addition, the communication network described in the present disclosure may include a wired/wireless communication network, and examples of such a wireless communication network may include Wireless LAN (WLAN), Digital Living Network Alliance (DLNA), Wireless Broadband (WiBro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc. Further, examples of the wired communication network may include a wired local area network (LAN) , wired wide area network (WAN) , power line communication (PLC), USB communication, Ethernet, serial communication, optical/coaxial cables, etc.

In addition, the offline store is located with one or more prize providing means 20 for a lottery event and one or more positioning means 30 for measuring the position of a customer terminal 10 in the offline store by communicating with the customer terminal 10 of a customer who has visited the offline store. The prize providing means 20 and the positioning means 30 may communicate with the local server 100 via a communication network.

In this case, the positioning means 30 may be configured as an access point (AP).

In addition, the prize providing means 20 stores a prize to be provided therein when a customer who participates in the lottery event wins, and may be provided with a locking device for opening and closing the prize providing means 20 to limit the customer to receive the prize only when the customer wins.

Further, the customer terminal 10 and the user terminal 40 described in the present disclosure may be configured by including a communication unit for communicating with an external device via a communication network, a user input unit for receiving a user input, a storage unit for storing various types of data, a global positioning system (GPS) unit for generating position information by measuring a current position, a sensor unit including various types of sensors, a display unit for displaying various types of information, and a control unit for controlling a configuration unit configured in the customer terminal 10 or the user terminal 40 to perform an overall control function of the customer terminal 10 and the user terminal 40.

In this case, the various types of sensors included in the sensor unit may include various sensors such as a geomagnetic sensor, a gyro sensor, and an acceleration sensor.

Examples of the customer terminal 10 and the user terminal 40 may include various terminals having a communication function, such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, a ultrabook, a wearable device (e.g., a smartwatch, a smart glass, a head mounted display (HMD), etc.), a Wibro terminal, an IPTV TV, an Internet Protocol Television (IPTV) terminal, a flexible terminal, and the like.

In addition, the local server 100 may transmit information related to the lottery event held in the offline store to the main server 200.

In addition, the main server 200 may manage the local server 100 located in the offline store, and may pre-store the space information in order to hold the same lottery event as the lottery event held at the offline store in an offline store which is space information on a 3D virtual space corresponding to the offline store generated by virtualizing the offline store using a digital twin.

In this case, the online store information to be described below may refer to the space information that is a 3D virtual space model obtained by virtualizing the offline store based on a digital twin.

Accordingly, the main server 200 may generate lottery event information based on the online store information in order to hold the same lottery event as the lottery event held at the offline store where the local server 100 is located in the online store information which is the 3D virtual space to include the generated lottery event information in the online store information and transmit the online store information including the lottery event information to the user terminal 40 accessing the main server 200.

In this case, the main server 200 may generate lottery event information including one or more objects corresponding to one or more prize providing means 20 located in the offline store, and the object may be a virtual prize providing means 20 virtualizing the prize providing means 20.

In addition, the main server 200 generates the lottery event information so that the object is located at a position in the online store information that is mapped with a point where the prize providing means 20 corresponding to the object is located in the offline store to include the generated lottery event information in the online store information.

In addition, the main server 200 may provide a web site including the online store information to the user terminal 40, provide the online store information to the user terminal 40 when the user terminal 40 accesses the main server 200, and provide the user terminal 40 to be movable in the virtual space according to the online store information based on movement request information received from the user terminal 40.

In this case, the online store information may include one or more product objects corresponding to one or more sale products displayed in the offline store, respectively, and the main server 200 may transmit product information pre-stored in response to object identification information to the user terminal 40 when receiving the object identification information for a product object selected from the one or more product objects from the user terminal 40 accessing the online store information. As a result, the main server 200 may provide information on sale products sold in the offline store to the user terminal 40, separately from the lottery event, so that the user of the user terminal 40 may purchase sale products sold in the offline store through the online store information.

Meanwhile, the main server 200 may confirm whether a customer who finds the prize providing means 20 in the offline store wins or not based on the information transmitted from the local server 100 to provide a prize stored in the prize providing means 20, or confirm whether a user who finds an object corresponding to the prize providing means 20 in the online store wins to provide a prize matched with the corresponding object to the user. As a result, the main server 200 may fusion the offline store as the real space and the online store as the virtual space to hold a fusion lottery event which is the same lottery event simultaneously in the offline store and the online store and support participants who visit the offline store or online store to participate in the fusion lottery event to acquire prizes to be provided according to the fusion lottery event by visiting the offline store or accessing the online store.

That is, the main server 200 integrates the events of the offline store and the online store in connection with the local server 100 to hold a fusion lottery event by determining a participant who first finds the prize providing means 20 as a prize winner with respect to customers visiting the offline store and users accessing and visiting the online store.

Accordingly, the event service providing system according to the present disclosure supports the participants to participate in the lottery event at a desired place of the offline store and the online store by holding the fusion lottery event of the offline store and the online store to increase the store utilization rate of both the offline store and the online store, thereby maximizing the sales.

However, in the process of holding the fusion lottery event as described above, since a time error occurs between the local server 100 and the main server 200 depending on a communication situation between the local server 100 and the main server 200, when a customer who finds a prize disposed in the offline store and a user who finds a virtual prize of an online store applied to the online store identical to the prize disposed in the offline store find the same prize with a slight time difference, an error may occur in determination of a winner between the customer and the user due to the time error. The customer who visits the offline store needs to move directly to the store, whereas the user who visits the online store may move conveniently and quickly to the store just by touching his/her terminal, and as a result, there may be a problem that in the process of holding the fusion lottery event, the customers may avoid the visiting of the offline store.

Hereinafter, a detailed operation embodiment of an event service providing system for providing a fusion lottery event capable of improving the satisfaction of all participants participating in the fusion lottery event by visiting offline and online stores by solving these problems will be described.

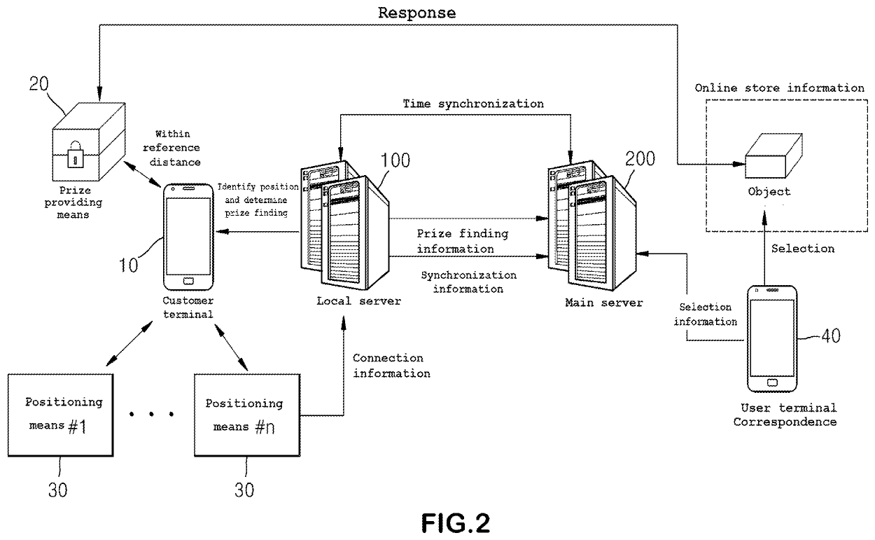

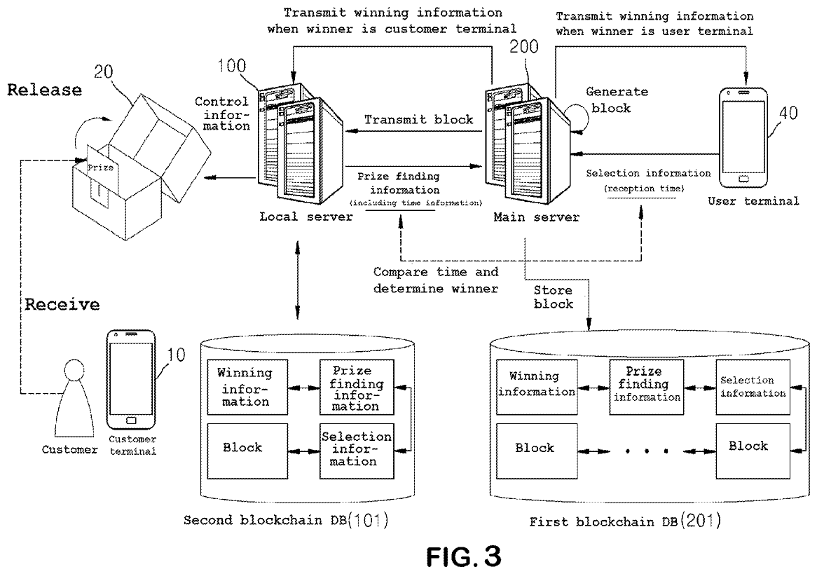

FIGS. 2 and 3 are operation exemplary diagrams of an event service providing system according to an embodiment of the present disclosure.

As illustrated in FIGS. 2 and 3, one or more prize providing means 20 may be disposed in an offline store where a lottery event is held.

At this time, the prize providing means 20 may be configured to include a case for storing prizes therein, a communication module for communication with the local server 100, a locking device for opening and closing the prize providing means 20 in order to limit acquisition until winning of the prize stored inside the prize providing means 20 is confirmed, and a control module that communicates with the local server 100 through the communication module and controls opening and closing of the locking device. The communication module, the locking device, and the control module may be configured in the case.

In addition, one or more positioning means 30 for determining the position of a customer who has visited the offline store may be disposed in the offline store. A positioning means 30 adjacent to the customer terminal 10 among the one or more positioning means 30 communicates with the customer terminal 10 to obtain terminal identification information of the customer terminal 10 and then generates connection information including the terminal identification information and identification information of the positioning means 30 preset in the positioning means 30 to transmit the connection information to the local server 100.

In addition, information about one or more prizes corresponding to one or more prizes located in the offline store may be pre-stored in the local server 100, and each of the one or more pieces of prize information may include prize position information on the position where the prize is disposed in the offline store, prize identification information on the prize, and identification information of the prize providing means 20 in which the prize is stored.

In addition, in the local server 100, the information on the positioning means 30 including the identification information and the position information of the positioning means 30 may be preset in the local server 100 for each of one or more positioning means 30.

Accordingly, when the local server 100 receives the connection information from one or more positioning means 30 communicating with the customer terminal 10 located in the offline store, the local server 100 may confirm the position information of the positioning means 30 pre-stored by matching the identification information of the positioning means 30 included in the connection information and identify a current position of the customer terminal 10 in the offline store based on the confirmed position information for each positioning means 30.

In addition, when there is a specific prize located within a preset reference distance from the current position by comparing the current location of the customer terminal 10 in the offline store with the information on one or more prizes, the local server 100 may determine that the customer of the customer terminal 10 finds the specific prize and generate prize finding information including terminal identification information of the customer terminal 10 included in the connection information and the prize identification information corresponding to the specific prize.

In this case, the local server 100 may count the time according to standard time, and transmit, to the main server 200, time information about the current time to be included in the prize finding information when generating the prize finding information, wherein the current time maybe prize finding time.

Meanwhile, the main server 200 may pre-store space information on a 3D virtual space including 3D actual measurement information of the offline store generated based on the digital twin to correspond to the offline store.

In this case, the space information may be 3D graphic information or a 3D virtual model virtualized with the same structure as that of the offline store.

In addition, the main server 200 may store the space information as online store information.

In addition, one or more objects corresponding to one or more prize providing means 20 located in the offline store may be included in advance in the space information, and each of the one or more objects may be included in the online store information so as to be located at a point (or coordinates) in the online store information that is mapped with the position of the prize providing means 20 in the offline store corresponding to the object.

In addition, the main server 200 may generate lottery event information on the lottery event held in the online store based on the online store, and then transmit the lottery event information included in the online store to the user terminal 40 accessing the main server 200.

That is, the main server 200 may transmit the online store information including the lottery event information to the user terminal 40 participating in the lottery event according to the online store.

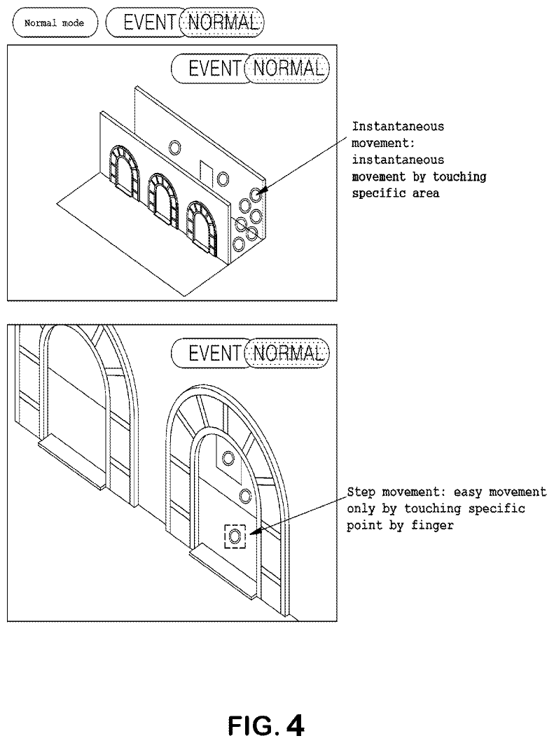

At this time, as illustrated in FIG. 4, the user terminal 40 receiving the online store information may display space information on the online store according to the online store information, and move in the space information according to a user input.

In the above configuration, the main server 200 may provide all movement types such as inter-floor movement and instantaneous movement in the online store information to be used for the user terminal 40 not participating in the lottery event.

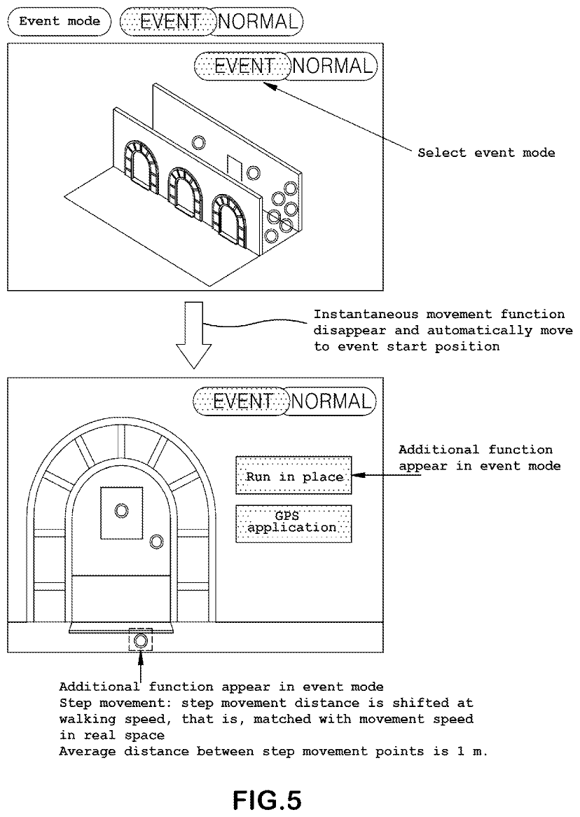

In addition, as illustrated in FIG. 5, when the lottery event information preset in the online store information transmitted from the user terminal 40 to the user terminal 40 is selected and event participation application information generated by the user terminal 40 is received, the main server 200 may divide the space information according to the online store information into a plurality of different areas, and transmit start area information on a predetermined start area among the plurality of areas to the user terminal 40 that requests the participation application in the lottery event according to the lottery event information.

That is, when the lottery event information included in the online store information is selected when receiving the online store information, the user terminal 40 may generate event participation application information based on the lottery event information to transmit the generated event participation application information to the main server 200. When receiving the event participation application information, the main server 200 may transmit, to the user terminal 40, start area information on a predetermined start area among a plurality of different area information obtained by dividing the space information according to the online store information to provide the user of the user terminal 40 to participate in the lottery event.

In this case, the main server 200 may also provide the area information as the online store information.

In addition, the main server 200 may control the user of the user terminal 40 to depart from the start area of the online store when participating in the lottery event in consideration of equity with customers participating in the lottery event in the offline store, and transmit area information or online store information limited to use only a predetermined specific movement type among the plurality of movement types usable when not participating in the lottery event to the user terminal 40 to control the user of the user terminal to participate in the lottery event.

As an example, the main server 200 may transmit area information or online store information set so as not to use a movement type such as inter-floor movement or instantaneous movement when receiving the event participation application information from the user terminal 40, and provide the area information or online store information by setting a movement speed in the area information or online store information transmitted to the user terminal 40 in relation to the lottery event as a preset reference movement speed.

At this time, the main server 200 may also set the movement speed in the area information or online store information transmitted in relation to the lottery event as an average movement speed in the offline store according to offline event progress information received from the local server 100 to be described below.

In addition, the user terminal 40 may generate movement request information on the movement area for moving from the start area information to another area according to the user input to transmit the generated movement request information to the main server 200, and the main server 200 may transmit other area information corresponding to the movement request information among the plurality of area information to the user terminal 40.

In addition, the user terminal 40 may generate selection information on a selected object when the object is included in the current area information displayed on the current user terminal 40 among the plurality of area information and the object is selected according to the user input to transmit the generated selection information to the main server 200.

In this case, the user terminal 40 may extract object identification information on the selected object from the online store information or the current area information, and then generate selection information including the object identification information and the terminal identification information preset in the user terminal 40 to transmit the generated selection information to the main server 200.

That is, when an object corresponding to the prize providing means 20 is selected in the online store according to the user input, the user terminal 40 may generate selection information including the object identification information preset in the selected object on the selected object and the terminal identification information of the user terminal 40 to transmit the generated selection information to the main server 200.

In the aforementioned configuration, the online store information and the plurality of area information for each area maybe configured as a 3D model . Accordingly, the user terminal 40 may rotate the space information or the area information according to a user input for the online store information or the area information to change a visible area or change a viewpoint.

In addition, the prize information on the prize stored in the prize providing means 20 located in the offline store may be matched with the object identification information of the object matching the prize providing means 20 and stored in the main server 200. Accordingly, the prize information may be matched with the identification information of the object included in the online store information corresponding to the prize information for each of the one or more prizes corresponding to each of the one or more prizes located in the offline store to be store in the main server 200.

In addition, the information about one or more prizes stored in the main server 200 maybe the same as the information stored in the local server 100, and each of the one or more pieces of prize information may include prize position information on the position where the prize is disposed in the offline store, prize identification information on the prize, and identification information of the prize providing means 20 in which the prize is stored.

To this end, the main server 200 may be configured by including a prize DB which stores prize information on prizes of the offline store matching the object identification information for each of one or more objects included in the online store information.

meanwhile, in order to determine a participant with an earlier finding time as a winner of a customer who is a participant in a lottery event who visits the offline store and finds the prize providing means 20 and a user who is a participant in a lottery event who accesses the online store information and finds an object corresponding to the prize providing means 20 found by the customer, the local server 100 may periodically or in real time generate synchronization information for time synchronization with the main server 200 and transmit the generated synchronization information to the main server 200.

That is, in the process of holding the same fusion lottery event between the online store virtualized in the same manner as the offline store based on a digital twin and the offline store, time delay occurs depending on a communication network situation between the local server 100 and the main server 200. Since such time delay causes a time error between the local server 100 and the main server 200, when the fusion lottery event is held without correction of the time error, before the prize finding information transmitted to the main sever 200 is received to the main server 200 according to the finding of the prize providing means 20 of the customer in the local sever 100 even if the customer first finds the prize providing means 20 in the offline store, it may be determined that the selection information on the object corresponding to the prize providing means 20 found by the customer in the online store is first received from the user terminal 40, and the reception time of the selection information is earlier than the time information of the prize finding information according to the time error. Accordingly, since there may be a problem that the user is determined as a winner even though the customer is the winner, there is a need for a synchronization process for correcting the time error according to the network delay between the main server 200 and the local server 100 in order to hold the fusion lottery event.

Accordingly, the main server 200 may perform time synchronization whenever synchronization information is received from the local server 100.

According to the aforementioned configuration, the main server 200 may receive the prize finding information from the local server 100 and may receive the selection information from the user terminal 40.

In this case, the main server 200 retrieves the prize DB based on the object identification information included in the selection information when receiving the selection information from the user terminal 40 to identify prize information matching the object identification information. In addition, the main server 200 identifies a reception time of the selection information by counting the time for which the time error with the local server 100 is corrected according to the time synchronization, while extracting prize identification information from the identified prize information to include the extracted prize identification information in the selection information and may include the reception time of the selection information in the selection information.

Meanwhile, the main server 200 and the local server 100 maybe configured as nodes of a blockchain, and each of the main server 200 and the local server 100 may be configured by including a blockchain DB for storing block generated based on the blockchain.

In addition, the blockchain described in the present disclosure may mean a plurality of nodes for executing an algorithm which commonly manages security information by constituting a plurality of pieces of transaction information into blocks and connecting many blocks to each other like a chain using a hash to distribute and store the information in digital equipment of nodes which are participants (peers) other than a central management server in a P2P network distribution environment. Accordingly, the event service providing system may be configured as a blockchain, and the blockchain may be configured by including the main server 200 and the local server 100, which are a plurality of nodes for operating by executing the blockchain related algorithm.

When using such a blockchain, since forgery of data is impossible, it is possible to perform reliable and secure transactions and data processing even without an authoritative agency, and in the present disclosure, to secure the reliability and integrity of the data used in the process of determining the winner among users and customers who found the same prize.

In addition, the main server 200 and the local server 100 configuring the nodes may be configured by including various configuration units such as a communication unit for communication with each other node, a display unit for displaying various types of information, a storage unit for storing various data including data on the blockchain-related algorithm and blocks generated through the blockchain, a user input unit for receiving a user input, a control unit for performing the overall control function of the nodes, and the like, wherein the control unit may control a configuration unit configuring the node.

At this time, the control unit executes the overall control function of the node using programs and data stored in the storage unit configured in the node. The control unit may include a RAM, a ROM, a CPU, a GPU, and a bus, and the RAM, the ROM, the CPU, and the GPU may be connected to each other via a bus.

In addition, as described above, the storage unit may be configured by a blockchain database (hereinafter, referred to as a blockchain DB) , or various storage units such as a physical hard disk, a solid state drive (SSD), and a web hard, and the blockchain DB may be configured as a blockchain-based shared ledger.

Accordingly, the main server 200 may generate a blockchain-based block including the prize finding information or selection information when receiving the prize finding information or selection information to be connected with the other block generated immediately before the block in a first blockchain DB 201 which is a blockchain DB included in the main server 200 through a block hash and stored in the first blockchain DB 201.

In this case, when the block including the selection information is generated, the main server 200 may generate the block using the selection information including the prize identification information and the reception time of the selection information.

In addition, the main server 200 may transmit the block to the local server 100 constituting the node of the blockchain when the block is generated, and when receiving the block from the main server 200, the local server 100 may connect the corresponding block with the other block generated immediately before the block in a second blockchain DB 101 which is a blockchain DB included in the local server 100 through a block hash and store the block in the second blockchain DB 101 of the local server 100.

According to the above configuration, when receiving the prize finding information, the main server 200 may retrieve the first blockchain DB 201 based on the prize identification information included in the prize finding information, and retrieve whether selection information including the prize identification information exists in the first blockchain DB 201.

Alternatively, when receiving the selection information, the main server 200 may retrieve the prize DB based on the object identification information included in the selection information, extract prize identification information included in the prize information matching the object identification information from the prize DB, and then retrieve the first blockchain DB 201 based on the extracted prize identification information, and retrieve whether the prize finding information including the extracted prize identification information exists in the first blockchain DB 201.

In addition, when the selection information including the same prize identification information as the prize identification information according to the prize finding information exists in the first blockchain DB 201 and the prize finding information including the same prize identification information as the prize identification information according to the selection information exists in the first blockchain DB 201, the main server 200 may compare the selection information with the prize finding information corresponding to the same prize as each other.

At this time, the main server 200 may compare the reception time of the selection information included in the selection information with the time information included in the prize finding information to select the earliest comparison target information among a plurality of comparison target information including the prize finding information and the selection information and then select a participant corresponding to the terminal identification information included in the selected comparison target information as a winner.

For example, when the time information included in the prize finding information is 2:15:10 and the reception time of the selection information is 2:15:11, a customer (customer terminal 10) who is a participant corresponding to the terminal identification information included in the prize finding information may be determined as a winner (winning terminal).

In the above configuration, the main server 200 receives the prize finding information or selection information to retrieve the first blockchain DB 201. As a result, when the selection information on the same prize as the received prize finding information does not exist or the prize finding information on the same product as the received selection information does not exist, the main server 200 may count the time from the reception time of the received prize finding information to determine the customer terminal 10 corresponding to the received prize finding information as the winning terminal when the selection information on the same prize as the received prize finding information is not received within a preset reference time, or count the time from the reception time of the received selection information to determine the user terminal 40 corresponding to the received selection information as the winning terminal when the prize finding information on the same prize as the received selection information is not received within a preset reference time.

In addition, when the winner is a customer who has visited the offline store, the main server 200 may transmit winning information including prize identification information included in the prize finding information and terminal identification information to the local server 100.

At this time, the main server 200 may extract the prize information corresponding to the prize identification information included in the prize finding information from the prize DB, and then generate winning information including the extracted prize information and the terminal identification information included in the prize finding information to transmit the generated winning information to the local server 100.

In addition, the local server 100 may extract identification information of the prize providing means 20 from pre-stored prize information corresponding to the prize identification information included in the winning information or prize information included in the winning information when receiving the winning information to identify the prize providing means 20 corresponding to the winning information based on the extracted identification information of the prize providing means 20 and transmit control information for releasing the locking device of the identified the prize providing means 20 to the prize providing means 20.

Accordingly, the control module of the prize providing means 20 releases the locking of the locking device configured in the prize providing means 20 when receiving the control information through the communication module and provide the prize stored in the prize providing means 20 to be received by the customer.

In addition, when the winner (winning terminal) is a user (user terminal 40 of the user) who accesses and visits the online store, the main server 200 may identify the user terminal 40 of the user based on the terminal identification information included in the selection information, extract prize information corresponding to prize identification information included in the selection information from the prize DB, and then generate winning information including the prize information to transmit the generated winning information to the identified user terminal 40 corresponding to the selection information.

In this case, the prize information included in the winning information may be an exchange ticket, a coupon, or the like including the right to receive the prize stored in the prize providing means 20 located in the offline store corresponding to the prize information, and the user may receive a prize stored in the prize providing means 20 located in the offline store by presenting the winning information in the offline store.

Meanwhile, the main server 200 may generate a new block including the winning information when generating the winning information, and connect the new block with a previous block which is generated immediately before generating the new block and stored in the first blockchain DB 201 based on a block hash to store the new block in the first blockchain DB 201.

In addition, the main server 200 may transmit the new block to the local server 100 when generating the new block, and the local server 100 may connect the new block with a previous block which is stored in the second blockchain DB 101 immediately before receiving the new block from the second blockchain DB 101 of the local server 100 through a block hash when receiving the new block from the main server 200 to store the new block in the second blockchain DB 101.

As described above, the main server 200 may also store information on a winner determined by comparing the finding time between the customer and the user in the blockchain while storing information on finding time of the customer finding the prize in the offline store and information on finding time of the user finding the prize in the online store in the blockchain in the process of holding the fusion lottery event by providing the same event simultaneously in the offline store and the online store. Accordingly, it is possible to support the information on the finding time of the customer and the finding time of the user to have reliability and integrity without being changed through the blockchain and also support the information on the determined winner to have reliability and integrity through the blockchain, thereby securing fairness and reliability of the lottery process and increasing the satisfaction of participants participating in the corresponding fusion lottery event.

As described above, the event service providing system generates virtual space information having the same structure as the offline store as an online store using a digital twin for the offline store and then applies one or more objects virtualizing one or more prize providing means 20 storing the prize disposed in the offline store to the online store to accurately determine a participant winning the prize among users who access and visit the online store and customers who actually visit the offline store through time synchronization between the local server 100 and the main server 200 in the process of holding the fusion lottery event for simultaneously providing the same lottery event between the offline store and the online store. In addition, the prize finding time for each of the users and the customers and the winner determination process are stored through a blockchain to increase reliability and satisfaction of the user in the lottery process of the fusion lottery event and support products to be sold in both the online store and the offline store to be exposed to the customers and the users through the fusion lottery event progress, thereby increasing the sales in both the online store and the offline store by one event progress.

Meanwhile, in the service providing process of the aforementioned fusion lottery event, since a customer who visits the offline store needs to actually move inside the offline store, whereas a user who accesses and visits the online store may easily move in the online store only with a simple operation through his or her user terminal 40, the online store is very advantageous in terms of mobility convenience. Accordingly, customers who participate in the fusion lottery event through an offline store are at a disadvantage in competition for participating in the fusion lottery event as compared to users who participate in the fusion lottery event through the online store, and as a result, all participants eventually participate in the fusion lottery event through the online store, which may cause a problem in which the efficiency of the offline store event is reduced.

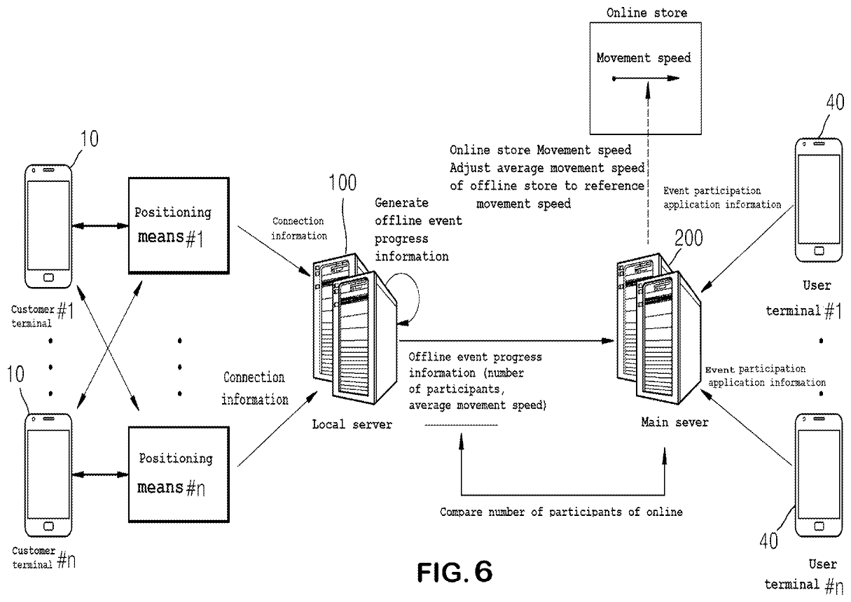

Accordingly, the event service providing system according to the present disclosure adjusts the difficulty of finding prizes in the online store based on the event progress of each of the offline store and the online store in order to minimize a difference in prize finding frequency between the offline and online stores when holding the fusion lottery event by integrating the offline store and the online store to secure the fairness and equity in winning the fusion lottery event between the offline store and the online store, which will be described in detail with reference to FIGS. 5 and 6.

As illustrated in FIGS. 5 and 6, the local server 100 may calculate an average movement speed according to the number of participants located in the offline store and the movement speed of each participant based on terminal identification information included in each of the connection information for one or more different customer terminals 10 received from each of the one or more positioning means 30 located in the offline store and positioning means 30 information for each of one or more positioning means 30.

At this time, the local server 100 may calculate the movement speed for each customer terminal 10 by tracking the same customer based on the connection information and the positioning means 30 information, and may calculate an average movement speed of customers moving in the offline store by collecting the movement speeds for each customer terminal 10.

In addition, the local server 100 may generate offline event progress information including the number of participants and the average movement speed and transmit the generated offline event progress information to the main server 200.

In addition, the main server 200 may calculate the number of participants corresponding to the online store based on the event participation application information received from one or more user terminals 40 participating in the lottery event of the online store, and generate online event progress information including the calculated number of participants for the online store.

In addition, the main server 200 may calculate a difference value according to the comparison of the number of participants between the offline event progress information and the online event progress information.

In addition, a plurality of different difficulty ranges and adjustment values for each difficulty range may be preset in the main server 200, and the main server 200 may calculate the movement speed by adding or subtracting an adjustment value corresponding to the difficulty range to which the difference value belongs to or from the average movement speed according to the offline event progress information, and adjust the movement speed in the online store to move at the calculated movement speed when moving in the online store by the operation of the user terminal 40.

For example, the main server 200 may provide start area information on a start area among a plurality of area information constituting online store information when receiving the event participation application information from the user terminal 40, and adjust the movement speed in the online store by subtracting a predetermined adjustment value corresponding to the difference value for the number of participants between the online store and the offline store from the average movement speed calculated for the offline store so as to be slower than the average movement speed in the offline store when the number of participants in the online store is greater than the number of participants in the offline store.

Alternatively, the main server 200 may adjust the movement speed in the online store by adding a predetermined adjustment value corresponding to the difference value for the number of participants between the online store and the offline store to the average movement speed calculated for the offline store so as to be faster than the average movement speed in the offline store when the number of participants in the offline store is greater than the number of participants in the online store.

Accordingly, when receiving the movement request information from the user terminal 40, the main server 200 may transmit, to the user terminal 40, area information on a next movement area selected according to the adjusted movement speed from the current area information in which the user terminal 40 is located among a plurality of different area information constituting the online store information.

In the above configuration, the main server 200 limits the movement type of the user terminal 40 participating in the fusion lottery event through the online store by accessing the online store information only to the movement type corresponding to walking and may limit a predetermined different movement type such as inter-floor movement not to be used.

Further, in order to ensure equity between participants participating in the lottery event in the offline store and the participant participating in the lottery event in the online store, the main server 200 may divide the online store information into a plurality of area information when receiving the event participation application information for participating in the lottery event of the online store from the user terminal 40 and then transmit a start area information on a predetermined start area among the plurality of area information to limit the user terminal 40 to start in the start area information.

However, when the customer runs or moves faster than an average movement speed in the offline store, a user who accesses the online store is placed at a rather disadvantageous position, so that equity may be reversed.

Accordingly, the main server 200 may provide the user terminal 40 with a user interface including one or more buttons for each movement type for movement within the online store in the online store information or area information.

For example, the user interface may include a run in place button and a GPS application button, and the user terminal 40 may transmit, to the main server 200, movement request information including sensing information including a geomagnetic sensor, a gyro sensor, an acceleration sensor, etc. built in the user terminal 40 when the user runs in place or changes direction while holding the user terminal 40 after selecting the run in place button.

Accordingly, the main server 200 may calculate the movement direction and the movement speed according to the sensing information, and transmit, to the user terminal 40, area information corresponding to an area moving according to the calculation result calculated based on the sensing information among the plurality of areas constituting the online store to display the area information on the user terminal 40.

That is, the main server 200 may support the speed or direction change due to running in the offline store to be reflected even in the online store.

In addition, the user terminal 40 may measure a current position of the user through a GPS unit configured in the user terminal 40 when the GPS application button is selected, and measure the movement direction and the movement distance through the GPS unit when the user runs or changes the direction to generate movement information thereon and transmit the movement information to the main server 200.

Accordingly, when receiving the movement information, the main server 200 may transmit area information on an area moved according to the movement information from the current position in the online store to the user terminal 40.

As described above, the main server 200 may accurately reflect a real movement speed and a real movement distance to the online store generated by measuring the offline store based on a digital twin as a user who is accessing and visiting the online store runs or changes direction in reality.

In addition, the main server 200 may calculate a first prize finding frequency in the offline store based on the prize finding information received from the local server 100, calculate a second prize finding frequency in the online store based on the selection information received from the one or more user terminals 40, and adjust the movement speed according to the operation of the user terminal 40 in the online store until a difference between the first prize finding frequency and the second prize finding frequency is within a predetermined threshold.

For example, the main server 200 may increase the movement speed until the difference between the first prize finding frequency and the second prize finding frequency is within the predetermined threshold when the first prize finding frequency is higher than the second prize finding frequency by a predetermined threshold or more (or exceeding the predetermined threshold). In addition, the main server 200 may decrease the movement speed in the online store until the difference between the first prize finding frequency and the second prize finding frequency is within the predetermined threshold when the first prize finding frequency is lower than the second prize finding frequency by a predetermined threshold or more (or exceeding the predetermined threshold).

As described above, according to the present disclosure, considering the number of participants and the prize finding frequency and mobility with respect to participants participating in the fusion lottery event in each of the offline store and the online store, the difficulty of movement of the online store is adjusted so that the frequencies of winning prizes are similar between the offline store and the online store to secure fairness and equity in the process of holing the fusion lottery event between offline and online stores, thereby supporting participants to be evenly distributed in both offline and online stores. Accordingly, it is possible not only to support both offline and online stores to ensure the promotion efficiency of the event progress, but also to support both the offline and online stores to increase the event participation satisfaction of all participants participating in the fusion lottery event.

For example, the components described in the embodiments of the present disclosure may be implemented using one or more general-purpose computers or special-purpose computers, such as hardware such as a storage unit such as a memory, a processor, a controller, an arithmetic logic unit (ALU), a digital signal processor, a microcomputer, a field programmable gate array (FPGA), a programmable logic unit (PLU), and a microprocessor, software including instruction sets, and combinations thereof, or other any devices capable of executing and responding instructions.

The aforementioned contents can be corrected and modified by those skilled in the art without departing from the essential characteristics of the present disclosure. Therefore, the exemplary embodiments disclosed in the present disclosure are intended not to limit the technical spirit of the present disclosure but to describe the present disclosure and the scope of the technical spirit of the present disclosure is not limited by these exemplary embodiments. The protective scope of the present disclosure should be construed based on the appended claims, and all the technical spirits in the equivalent scope thereof should be construed as falling within the scope of the present disclosure.

What is claimed is:

1. An event service providing system using a digital twin of a real space and a virtual space, comprising a local server for managing an offline store which is a real store and a main server for communicating with the local server via a communication network, the event service providing system comprising:
the local server that transmits synchronization information for time synchronization with the main server and generates prize finding information including time information on a prize finding time and prize identification information of the specific prize and terminal identification information of the customer terminal when a predetermined position for a prize providing means located in the offline store to store a specific prize therein and a position of the customer terminal identified through communication with one or more positioning means located in the offline store are within a predetermined reference distance to transmit the generated prize finding information to the main server; and
the main server that stores online store information, which is a 3D virtual space including 3D measurement information generated based on a digital twin to correspond to the offline store, synchronizes the time with the local server based on the synchronization information, transmits the online store information to the user terminal while one or more objects matched with the one or more prize providing means located in the offline store are included in the position in the online store information matched with the positions in the offline store of the prize providing means corresponding to each object, and compares the time information of the prize finding information with the reception time of the selection information when a prize corresponding to the selection information when receiving the selection information corresponding to the object selected in the online store information from the user terminal is the same as the specific prize according to the prize finding information received from the local server to determine a winning terminal winning the specific prize in the customer terminal and the user terminal.

2. The event service providing system of claim 1, wherein the main server and the local server are configured as nodes of a blockchain, respectively, and
the main server generates a block including the prize finding information or selection information when receiving the prize finding information or the selection information and then connects the block with the other block generated immediately before the block through a block hash to store the block, and transmits the block to the local server to distribute and store the block in the local server.

3. The event service providing system of claim 2, wherein the main server pre-stores prize information on a prize of the offline store matched with object identification information of the object for each of the one or more objects,
the main server includes a reception time of the selection information when receiving the selection information and prize identification information extracted from the prize information matched with the object identification information of the selected object included in the selection information in the selection information, and
the main server retrieves the blockchain based on the prize finding information or the prize identification information included in the selection information when receiving the prize finding information or the selection information and compares the reception time of the selection information and the time information of the prize finding information between the received prize finding information or selection information and the prize finding information or selection information for the specific prize stored in the blockchain when selection information on the same prize as the specific prize corresponding to the received prize finding information exists or prize finding information on the same prize as the specific prize corresponding to the received selection information exists.

4. The event service providing system of claim 2, wherein the main server compares the reception time of the selection information with the time information of the prize finding information to identify a winning terminal based on terminal identification information included in the earliest comparison target information among a plurality of comparison target information including the selection information and the prize finding information, and transmits winning information to the winning terminal that has won the specific prize in the customer terminal and the user terminal.

5. The event service providing system of claim 4, wherein the main server generates the winning information for releasing a locking state of the prize providing means having a locking device so as not to receive the specific prize stored in the prize providing means before winning when the winning terminal winning the specific prize is the customer terminal to transmit the generated winning information to the local server, and
the local server generates control information for releasing the locking device of the prize providing means based on the winning information when receiving the winning information to transmit the generated control information to the prize providing means.

6. The event service providing system of claim 4, wherein the main server generates winning information including prize information including the right to receive the specific prize stored in the prize providing means located in the offline store when the winning terminal winning the specific prize is the user terminal to transmit the generated winning information to the user terminal.

7. The event service providing system of claim 4, wherein the main server generates a new block including the winning information when generating the winning information and then connects the new block with a previous block generated immediately before generating the new block based on a block hash to store the new block, and transmits the new block in the local server to distribute and store the new block in the local server.

8. The event service providing system of claim 1, wherein the local server identifies one or more customer terminals located in the offline store by communicating with the one or more positioning means to calculate an average movement speed according to the number of participants in the offline store and a movement speed for each participant and generates offline event progress information including the number of participants and the average movement speed to transmit the generated offline event progress information to the main server, and
the main server generates online event progress information including the number of participants in the online store corresponding to the online store information with respect to one or more user terminals participating in a lottery event in the online store by requesting the online store information, calculates a difference value according to the comparison of the number of participants between the offline event progress information and the online event progress information and then calculates a movement speed by adding or subtracting an adjustment value corresponding to a difficulty range to which the difference value belongs to or from the average movement speed according to the offline event progress information according to a plurality of preset adjustment values for each of different difficulty ranges, and adjusts the movement speed in the online store so as to move at the calculated movement speed when moving in the online store by the operation of the user terminal.

9. The event service providing system of claim 8, wherein the main server calculates a first prize finding frequency in the offline store based on the prize finding information received from the local server, calculates a second prize finding frequency in the online store based on the selection information received from the one or more user terminals, and adjusts the movement speed in the online store until a difference between the first prize finding frequency and the second prize finding frequency is within a predetermined threshold.

10. The event service providing system of claim 9, wherein the main server increases the movement speed in the online store when the first prize finding frequency is higher than the second prize finding frequency and decreases the movement speed in the online store when the first prize finding frequency is lower than the second prize finding frequency.
